(19) United States
(12) Patent Application Publication
(10) Pub. No.: US 2022/0220368 A1
(43) Pub. Date: Jul. 14, 2022

(54) METHOD FOR PREPARING PHOTORESPONSIVE SELF-POWERED ELECTROCHROMIC PRECURSOR, METHOD FOR FABRICATING PHOTORESPONSIVE SELF-POWERED ELECTROCHROMIC DEVICE AND PHOTORESPONSIVE SELF-POWERED ELECTROCHROMIC DEVICE FABRICATED BY THE FABRICATION METHOD

(71) Applicant: KOREA INSTITUTE OF ENERGY RESEARCH, Daejeon (KR)

(72) Inventors: Chi-hwan HAN, Daejeon (KR); Sung-jun HONG, Daejeon (KR); Kwan Woo KO, Daejeon (KR); Ji Su HAN, Cheonan-si, Chungcheongnam-do (KR)

(21) Appl. No.: 16/640,058

(22) PCT Filed: Apr. 10, 2018
(86) PCT No.: PCT/KR2018/004200

§ 371 Date: Oct. 26, 2021

(30) Foreign Application Priority Data
Dec. 5, 2017 (KR) 10-2017-0165982

(51) Int. Cl. C09K 9/02

(52) U.S. Cl. CPC C09K 9/02; C09K 2211/1007

(57) ABSTRACT

Disclosed are a method for producing a photoresponsive automatic color change precursor and a photoresponsive automatic color change element, and a photoresponsive automatic color change element produced thereby. A method for producing a photoresponsive automatic color change precursor and a photoresponsive automatic color change element, and a photoresponsive automatic color change element produced thereby according to the present invention are characterized in that the method includes a step for adding or adsorbing a ligand material to a reducing color change material, a semiconductor material, or an electron transfer material to produce a reducing color change mixture that changes color through a photoresponse. Accordingly, effects are exhibited wherein handleability and storability are facilitated by means of a simple structure, discoloration and color change can be performed by driving the photoresponsive automatic color change element by using electrical power self-generated using external light, and the rate of discoloration in particular is remarkably improved.

### TECHNICAL FIELD

The present invention relates to a method for preparing a photoresponsive self-powered electrochromic precursor, a method for fabricating a photoresponsive self-powered electrochromic device, and a photoresponsive self-powered electrochromic device fabricated by the fabrication method. More specifically, the present invention relates to a method for preparing a photoresponsive self-powered electrochromic precursor that is simple in structure, is easy to handle and store, is self-powered using external light, and uses the power to drive an electrochromic device for bleaching and coloring, particularly for remarkably rapid bleaching, a method for fabricating a photoresponsive self-powered electrochromic device that is simple in structure, is easy to handle and store, is self-powered using external light, and is driven using the power for bleaching and coloring, particularly for remarkably rapid bleaching, and a photoresponsive self-powered electrochromic device that is fabricated by the fabrication method, is simple in structure, is easy to handle and store, is self-powered using external light, and is driven using the power for bleaching and coloring, particularly for remarkably rapid bleaching.

### BACKGROUND ART

Electrochromism generally refers to a phenomenon in which a change in light transmittance or color takes place in the presence of an externally applied voltage. Electrochromism is featured by a low operating voltage of 1.5 V or less, high photochromic efficiency, and memory effects under open-circuit conditions, avoiding the need to continuously apply a voltage. Because of these features, electrochromism has many potential applications, for example, in smart windows, mirrors, displays, and optical switching devices.

FIG. 18 illustrates an exemplary electrochromic device having an electrochemical structure in which a WO₃ electrochromic layer is located on a transparent conductor to form a working electrode, an ion storage layer is located on a transparent conductor to form a counter electrode, and an electrolyte is interposed between the two electrodes. The electrochromic layer of the working electrode uses a material that is colored when a cathodic reaction occurs and is bleached when an anodic reaction occurs. Representative examples of suitable materials for the electrochromic layer include tungsten oxides, thallium oxides, niobium oxides, and molybdenum oxides.

The ion storage layer of the counter electrode serves to simply store or provide ions irrespective of the cathodic or anodic reaction. The ion storage layer may use a material that is colored when an anodic reaction occurs and is bleached when a cathodic reaction occurs, contrary to the electrochromic layer of the working electrode. The simultaneous coloring and bleaching in the counter electrode and the working electrode can lead to an improvement in the contrast of the device. Representative examples of suitable materials for the ion storage layer include nickel oxides, iridium oxides, and vanadium oxides.

Electrochromic devices can be developed into hybrid types with low-voltage power sources such as solar cells due to their much lower operating voltage (<1.5 V) than other display devices such as LEDs and liquid crystal display devices. For example, U.S. Pat. Nos. 5,384,653 and 5,377,037 disclose hybrids of electrochromic devices with p-n junction solar cells (or Si solar cells).

However, the solar cells need to be made translucent because of the opaque Si. To this end, the thickness of the solar cells should be limited to at most 100 nm. This makes it difficult to fabricate the solar cells, tends to cause a short circuit of the solar cells, and incurs high fabrication costs.

As solutions to these problems, there have been proposed short-wavelength semiconductor materials whose energy band gap without absorbing light in the visible region is larger than that for visible light. However, the choice of such semiconductor materials is limited and the use of the short-wavelength semiconductors incapable of absorbing visible light significantly deteriorates the characteristics of solar cells.

In consideration of such problems, Korean Patent No. 581966 discloses a self-powered electrochromic device constructed to drive a dye-sensitized solar cell module as an electrochromic device module. As illustrated in FIG. 19, the electrochromic device includes a transparent substrate, a semiconductor electrode including a transparent conductor and a light absorbing layer, a first electrolyte layer, and optionally, a catalyst layer between an upper electrode and the first electrolyte layer. However, this complex construction increases the fabrication cost of the electrochromic device and deteriorates the durability of the electrochromic device.

### DETAILED DESCRIPTION OF THE INVENTION

### Problems to be Solved by the Invention

The present invention has been made in an effort to solve the above-mentioned problems, and a first object of the present invention is to provide a method for preparing a photoresponsive self-powered electrochromic precursor that is simple in structure, is easy to handle and store, is self-powered using external light, and uses the power to drive a self-powered electrochromic device for bleaching and coloring, particularly for remarkably rapid bleaching.

A second object of the present invention is to provide a photoresponsive self-powered electrochromic precursor that is simple in structure, is easy to handle and store, is self-powered using external light, and uses the power to drive an electrochromic device for bleaching and coloring, particularly for remarkably rapid bleaching.

A third object of the present invention is to provide a method for fabricating a photoresponsive self-powered electrochromic device that is simple in structure, is easy to handle and store, is self-powered using external light, and is driven using the power for bleaching and coloring, particularly for remarkably rapid bleaching.

A fourth object of the present invention is to provide a photoresponsive self-powered electrochromic device that is simple in structure, is easy to handle and store, is self-powered using external light, and is driven using the power for bleaching and coloring, particularly for remarkably rapid bleaching.

### Means for Solving the Problems

In order to achieve the first object of the present invention, there is provided a method for preparing a photoresponsive self-powered electrochromic precursor, including adding or adsorbing a ligand material to a cathodic electrochromic material, a semiconductor material or an electron transport material to prepare a cathodic electrochromic mixture whose color changes in response to light.

In order to achieve the second object of the present invention, there is provided a photoresponsive self-powered electrochromic precursor including a cathodic electrochromic mixture which is prepared by adding or adsorbing a ligand material to a cathodic electrochromic material, a semiconductor material or an electron transport material and whose color changes in response to light wherein the cathodic electrochromic mixture is in the form of particles, colloid, solution or paste.

According to one embodiment of the present invention, the ligand material may be salicylic acid, a salicylic acid derivative, catechol, salicylaldehyde, saccharine, salicylamide, 1,4,5,8-naphthalenetetracarboxylic acid, 1,4,5,8-naphthalenetetracarboxylic anhydride, 1,8-naphthalic anhydride, 1-naphthoic acid, naphthol blue black or naphthol Green B.

According to a further embodiment of the present invention, the cathodic electrochromic material may be tungsten oxide (WO₃), copper oxide (CuO), molybdenum oxide (MoO₃), vanadium oxide (V₂O₅), thallium oxide (Tl₂O) or niobium oxide (Nb₂O₅).

According to another embodiment of the present invention, the semiconductor material may be an n-type semiconductor material, titanium dioxide (TiO₂), zinc oxide (ZnO), niobium oxide (Nb₂O₅), tin oxide (SnO₂), zinc tin oxide (Zn₂SnO₄) or strontium titanium oxide (SrTiO₃).

According to another embodiment of the present invention, the electron transport material may include a transition metal or carbon-based electron transport medium.

According to another embodiment of the present invention, the transition metal may include platinum or titanium.

According to another embodiment of the present invention, the carbon-based electron transport medium may be a carbon nanotube aggregate, graphite, graphene or fullerene.

In order to achieve the third object of the present invention, there is provided a method for fabricating a photoresponsive self-powered electrochromic device, including (S1) adding or adsorbing a ligand material to a cathodic electrochromic material, a semiconductor material or an electron transport material to prepare a cathodic electrochromic mixture whose color changes in response to light and fixing the cathodic electrochromic mixture to prepare a cathodic electrochromic composite in which electrically conductive paths are formed and (S2) immersing the cathodic electrochromic composite in an electrolyte.

According to one embodiment of the present invention, in step S1, the fixing may include applying the cathodic electrochromic mixture to a substrate.

According to another embodiment of the present invention, in step S1, the fixing may be performed by heat treatment or pressing to form electrically conductive paths.

According to another embodiment of the present invention, the electrolyte may include LiI, LiBr, LiSCN, LiSeCN, HI, HBr, HSCN or HSeCN.

In order to achieve the fourth object of the present invention, there is provided a photoresponsive self-powered electrochromic device fabricated by adding or adsorbing a ligand material to a cathodic electrochromic material, a semiconductor material or an electron transport material to prepare a cathodic electrochromic mixture whose color changes in response to light, fixing the cathodic electrochromic mixture to prepare a cathodic electrochromic composite in which electrically conductive paths are formed, and immersing the cathodic electrochromic composite in an electrolyte.

According to one embodiment of the present invention, the fixing may be performed by applying the cathodic electrochromic mixture to a substrate.

According to a further embodiment of the present invention, the fixing may be performed by heat treatment or pressing to form electrically conductive paths.

According to another embodiment of the present invention, the ligand material may be salicylic acid, a salicylic acid derivative, catechol, salicylaldehyde, saccharine, salicylamide, 1,4,5,8-naphthalenetetracarboxylic acid, 1,4,5,8-naphthalenetetracarboxylic anhydride, 1,8-naphthalic anhydride, 1-naphthoic acid, naphthol blue black or naphthol Green B.

According to a further embodiment of the present invention, the cathodic electrochromic material may be tungsten oxide (WO₃), copper oxide (CuO), molybdenum oxide (MoO₃), vanadium oxide (V₂O₅), thallium oxide (Tl₂O) or niobium oxide (Nb₂O₅).

According to another embodiment of the present invention, the semiconductor material may be an n-type semiconductor material, titanium dioxide (TiO₂), zinc oxide (ZnO), niobium oxide (Nb₂O₅), tin oxide (SnO₂), zinc tin oxide (Zn₂SnO₄) or strontium titanium oxide (SrTiO₃).

According to another embodiment of the present invention, the electron transport material may include a transition metal or carbon-based electron transport medium.

According to another embodiment of the present invention, the transition metal may include platinum or titanium.

According to another embodiment of the present invention, the carbon-based electron transport medium may be a carbon nanotube aggregate, graphite, graphene or fullerene.

According to another embodiment of the present invention, the cathodic electrochromic composite may have a plurality of pores formed three-dimensionally.

According to another embodiment of the present invention, the ratio of the space taken up by the plurality of pores to the volume of the cathodic electrochromic composite may be from 3:7 to 7:3.

### Effects of the Invention

The photoresponsive self-powered electrochromic precursor of the present invention is simple in structure, is easy to handle and store, is self-powered using external light, and uses the power to drive the photoresponsive self-powered electrochromic device for bleaching and coloring, particularly for remarkably rapid bleaching.

### BRIEF DESCRIPTION OF THE DRAWINGS

FIG. 1 is a surface SEM image of a cathodic electrochromic composite after heat treatment in Example 1.

FIG. 2 is a surface SEM image of a photoresponsive self-powered electrochromic composite after pressing under heat in Example 2.

FIG. 3A is an initial image of a photoresponsive self-powered electrochromic device fabricated in Example 1, FIG. 3B is an image showing a colored state of the photoresponsive self-powered electrochromic device after exposure to sunlight, and FIG. 3C is an image showing the photoresponsive self-powered electrochromic device returned to its original bleached state after exposure to and subsequent removal of sunlight.

FIG. 4A is an initial image of a photoresponsive self-powered electrochromic device fabricated in Example 2, FIG. 4B is an image showing a colored state of the photoresponsive self-powered electrochromic device after exposure to sunlight, and FIG. 4C is an image showing the photoresponsive self-powered electrochromic device returned to its original bleached state after exposure to and subsequent removal of sunlight.

FIG. 5 shows UV-Visible transmittance spectra for colored and bleached states of a photoresponsive self-powered electrochromic device fabricated in Example 1.

FIG. 6 shows UV-Visible transmittance spectra for colored and bleached states of a photoresponsive self-powered electrochromic device fabricated in Example 2.

FIG. 7 shows UV-Visible transmittance spectra for a colored state of a photoresponsive self-powered electrochromic device fabricated in Example 1 and bleached states of the electrochromic device after 5 m, 10 m, 30 m, 60 m, 120 m, 180 m, and 240 in.

FIG. 8 shows UV-Visible transmittance spectra of a colored state of a photoresponsive self-powered electrochromic device fabricated in Example 2 and bleached states of the electrochromic device after 5 m, 10 in, 30 in, 60 m, 120 m, 180 in, and 240 m.

FIG. 9 is a table showing the detailed results at a wavelength of 700 nm in FIG. 7.

FIG. 10 is a table showing the detailed results at a wavelength of 700 nm in FIG. 8.

FIGS. 11 and 12 are transmittance spectra of self-powered electrochromic devices fabricated in Examples 3 and 4, which were measured to investigate the time-dependent degrees of bleaching of the electrochromic devices after coloring.

FIG. 13 is a table showing the transmittances of photoresponsive self-powered electrochromic devices fabricated in Examples 3 to 8 at wavelengths of 550 nm and 700 nm.

FIG. 14 shows UV-Vis transmittance spectra of a self-powered electrochromic device fabricated Example 1, which were measured on different days during repeated coloring and bleaching.

FIG. 15 shows UV-Vis transmittance spectra of a self-powered electrochromic device fabricated Example 2, which were measured on different days during repeated to coloring and bleaching.

FIG. 16 is a table showing the detailed results at a wavelength of 700 nm in FIG. 14.

FIG. 17 is a table showing the detailed results at a wavelength of 700 nm in FIG. 15.

FIG. 18 is a conceptual cross-sectional view of an exemplary conventional self-powered electrochromic device.

FIG. 19 is a conceptual cross-sectional view of another exemplary conventional self-powered electrochromic device.

### BEST MODE FOR CARRYING OUT THE INVENTION

The present invention will now be described in detail.

Technical terms used in this specification are used to merely illustrate specific embodiments, and should be understood that they are not intended to limit the present invention.

As far as not being defined differently, technical terms used herein may have the same meaning as those generally understood by an ordinary person skilled in the art to which the present invention belongs to, and should not be construed in an excessively comprehensive meaning or an excessively restricted meaning. In addition, if a technical term used in the description of the present invention is an erroneous term that fails to clearly express the idea of the present invention, it should be replaced by a technical term that can be properly understood by the skilled person in the art. In addition, general terms used in the description of the present invention should be construed according to definitions in dictionaries or according to its front or rear context, and should not be construed to have an excessively restrained meaning. As used herein, the singular forms “a,” “an” and “the” are intended to include the plural forms as well, unless the context clearly indicates otherwise. The terms “comprises”, “comprising”, “includes” and/or “including” as used herein should not be construed to necessarily include all of the elements or steps disclosed herein, and should be construed not to include some of the elements or steps thereof, or should be construed to further include additional elements or steps. In the description of the present invention, detailed explanations of related art are omitted when it is deemed that they may unnecessarily obscure the essence of the invention.

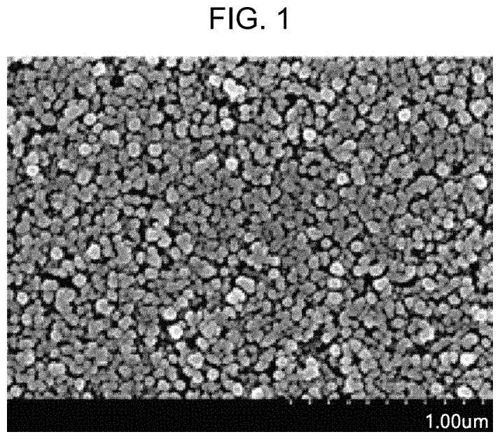

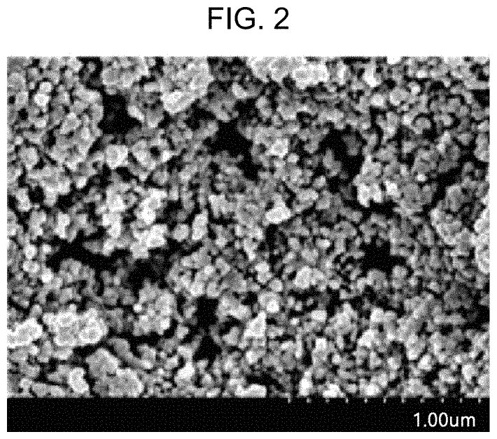

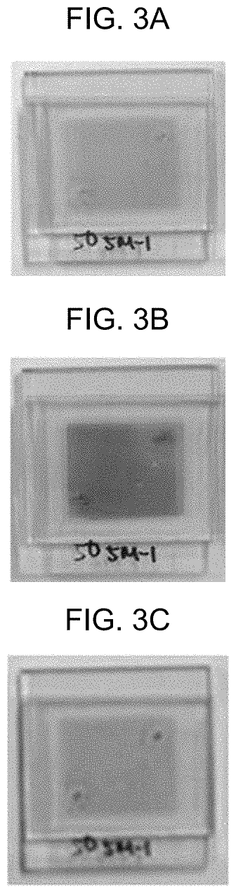

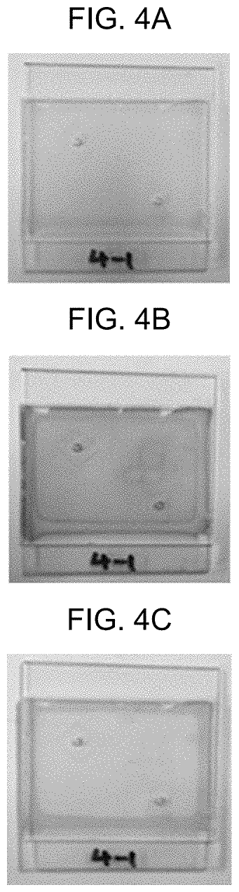

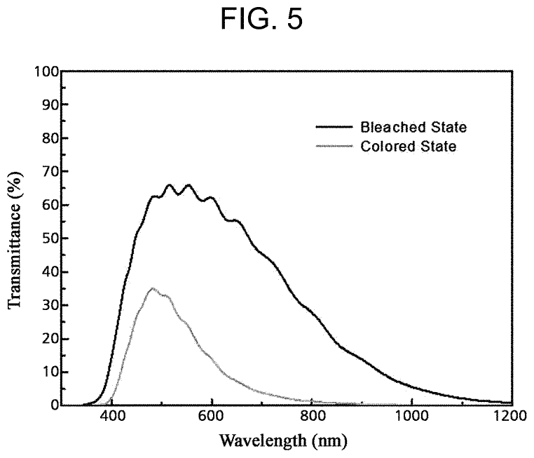

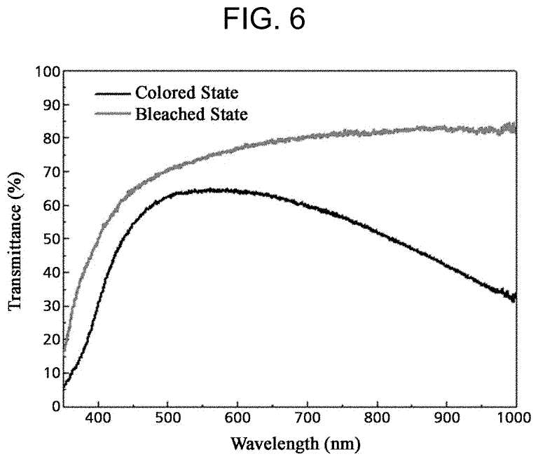

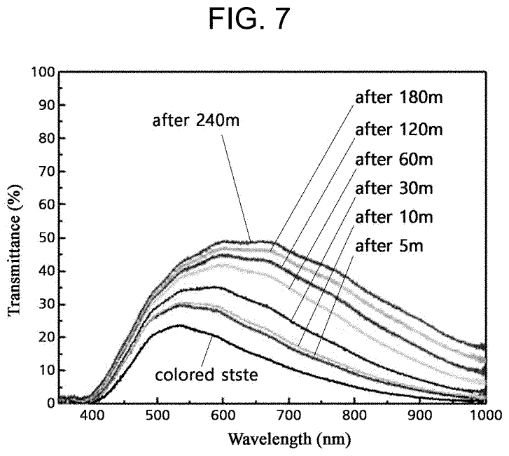

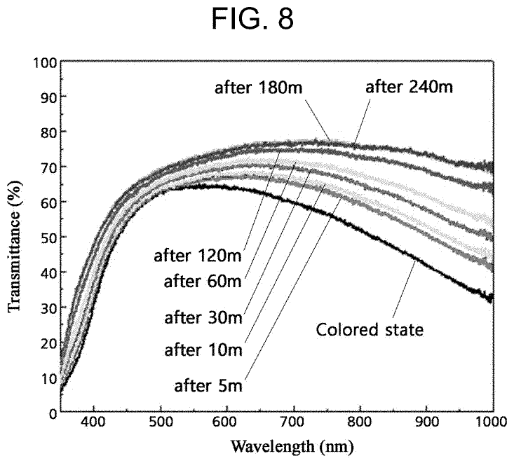

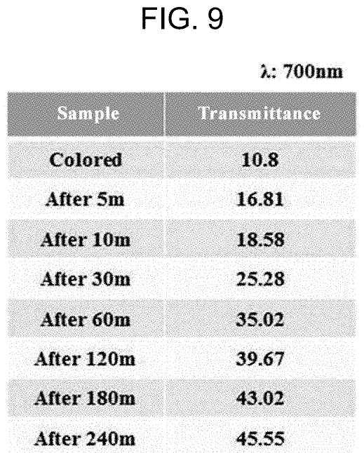

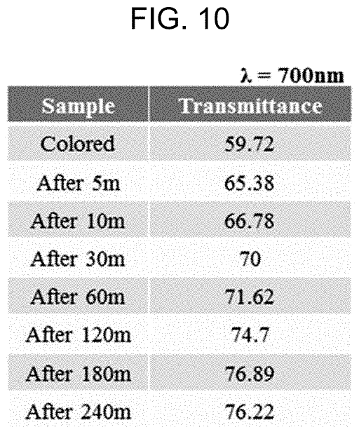

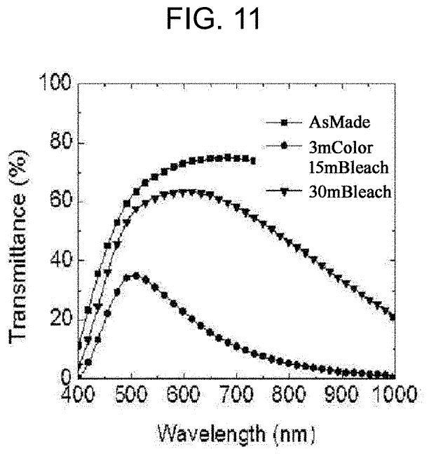

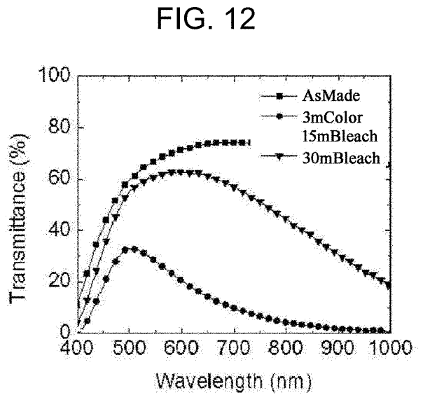

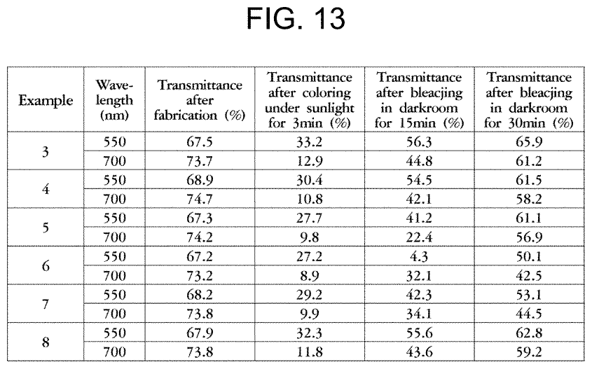

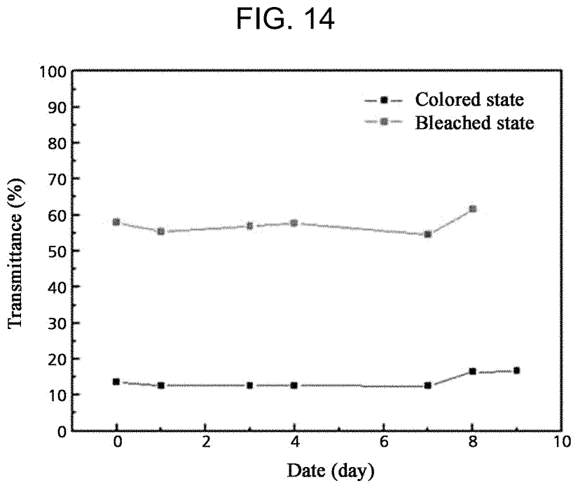

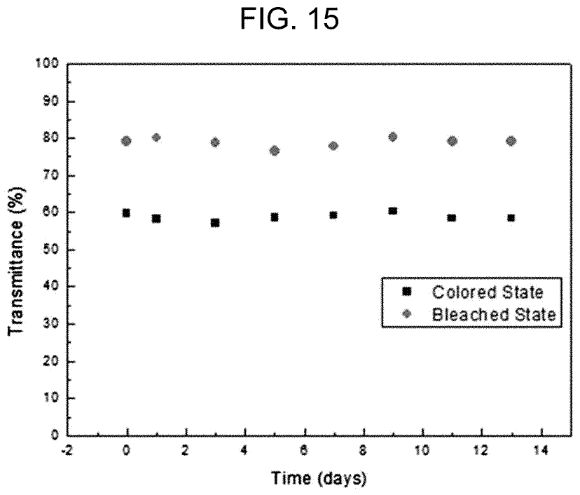

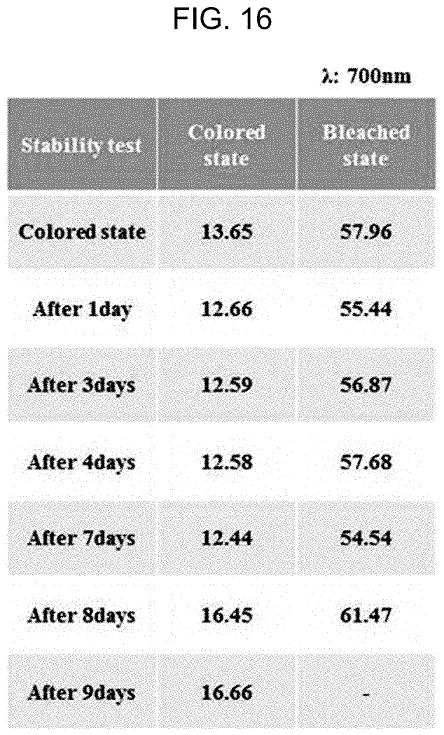

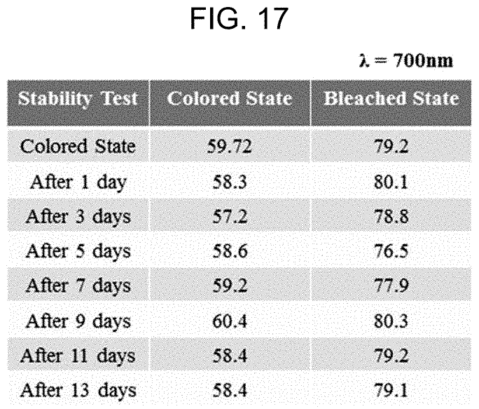

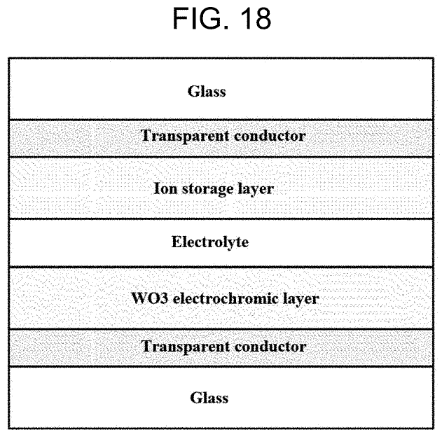

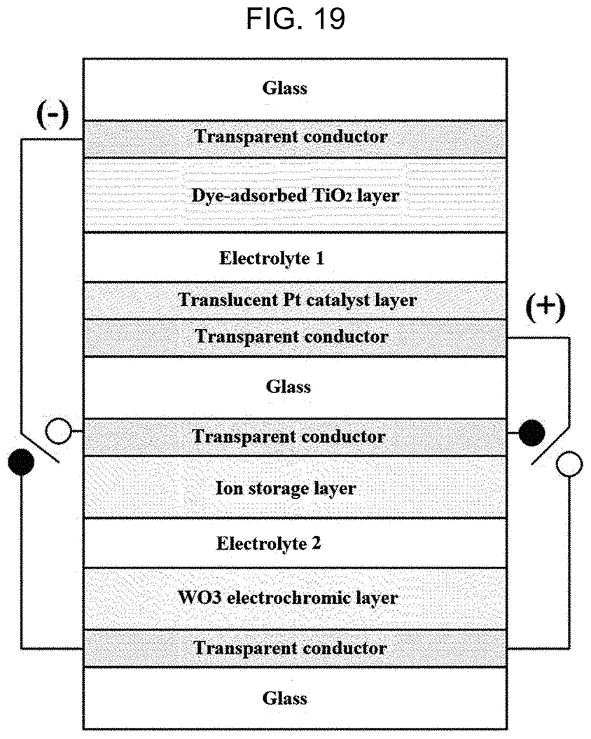

FIG. 1 is a surface SEM image of a cathodic electrochromic composite after heat treatment in Example 1; FIG. 2 is a surface SEM image of a photoresponsive self-powered electrochromic composite after pressing under heat in Example 2; FIG. 3A is an initial image of a photoresponsive self-powered electrochromic device fabricated in Example 1, FIG. 3B is an image showing a colored state of the photoresponsive self-powered electrochromic device after exposure to sunlight, and FIG. 3C is an image showing the photoresponsive self-powered electrochromic device returned to its original bleached state after exposure to and subsequent removal of sunlight; FIG. 4A is an initial image of a photoresponsive self-powered electrochromic device fabricated in Example 2, FIG. 4B is an image showing a colored state of the photoresponsive self-powered electrochromic device after exposure to sunlight, and FIG. 4C is an image showing the photoresponsive self-powered electrochromic device returned to its original bleached state after exposure to and subsequent removal of sunlight; FIG. 5 shows UV-Visible transmittance spectra for colored and bleached states of a photoresponsive self-powered electrochromic device fabricated in Example 1; FIG. 6 shows UV-Visible transmittance spectra for colored and bleached states of a photoresponsive self-powered electrochromic device fabricated in Example 2; FIG. 7 shows UV-Visible transmittance spectra for a colored state of a photoresponsive self-powered electrochromic device fabricated in Example 1 and bleached states of the electrochromic device after 5 in, 10 in, 30 in, 60 m, 120 m, 180 in, and 240 m; FIG. 8 shows UV-Visible transmittance spectra of a colored state of a photoresponsive self-powered electrochromic device fabricated in Example 2 and bleached states of the electrochromic device after 5 m, 10 m, 30 m, 60 in, 120 m, 180 m, and 240 m; FIG. 9 is a table showing the detailed results at a wavelength of 700 nm in FIG. 7; FIG. 10 is a table showing the detailed results at a wavelength of 700 nm in FIG. 8; FIGS. 11 and 12 are transmittance spectra of self-powered electrochromic devices fabricated in Examples 3 and 4, which were measured to investigate the time-dependent degrees of bleaching of the electrochromic devices after coloring; FIG. 13 is a table showing the transmittances of photoresponsive self-powered electrochromic devices fabricated in Examples 3 to 8 at wavelengths of 550 nm and 700 nm; FIG. 14 shows UV-Vis transmittance spectra of a self-powered electrochromic device fabricated Example 1, which were measured on different days during repeated coloring and bleaching; FIG. 15 shows UV-Vis transmittance spectra of a self-powered electrochromic device fabricated Example 2, which were measured on different days during repeated coloring and bleaching; FIG. 16 is a table showing the detailed results at a wavelength of 700 nm in FIG. 14; and FIG. 17 is a table showing the detailed results at a wavelength of 700 nm in FIG. 15. The present invention will be described with reference to these figures.

A method for preparing a photoresponsive self-powered electrochromic precursor according to the present invention includes adding or adsorbing a ligand material to a cathodic electrochromic material, a semiconductor material or an electron transport material to prepare a cathodic electrochromic mixture whose color changes in response to light.

Specifically, the ligand material may be added or adsorbed to the cathodic electrochromic material, the semiconductor material or the electron transport material by mixing or stacking.

The ligand material contributes to an electrochromism when adsorbed and may be previously adsorbed to the cathodic electrochromic material, the semiconductor material or the electron transport material before mixing. Alternatively, the ligand material may be added to the cathodic electrochromic material, the semiconductor material or the electron transport material by mixing. When it is intended to utilize the characteristics of the mixture in methods or products, the fact can be considered that the ligand material dominantly interacts with the semiconductor material compared to with the cathodic electrochromic material, and as a result, the majority of the ligand material is adsorbed to the semiconductor material particles.

That is, the attractive interaction between the ligand material and the semiconductor material is based on the bonding between the carboxyl, nitrile or hydroxyl group present in the organic ligand and the surface hydroxyl group of the semiconductor material by polycondensation. Once bonded, the ligand material can be maintained very stable. The ligand material is not particularly limited as long as it is maintained in a stable state despite the name “ligand”. For example, a functional polymer or a dye may also be used instead of the ligand material.

The ligand material adsorbed to the cathodic electrochromic material, the semiconductor material or the electron transport material (or particles thereof) provides electron migration paths when irradiated with light. For example, when the ligand-bound semiconductor material (e.g., TiO₂) absorbs the UV light or short-wavelength visible component of sunlight to excite electrons (e⁻) to the conduction band of the semiconductor material. At this time, holes are created in the HOMO of the ligand and the excited electrons are transferred to the adjacent cathodic electrochromic material (e.g., WO₃) to reduce W⁶⁺ to W⁵⁺, achieving a color change (e.g., a blue color).

Salicylic acid, a salicylic acid derivative, catechol, salicylaldehyde, saccharine, salicylamide, 1,4,5,8-naphthalenetetracarboxylic acid, 1,4,5,8-naphthalenetetracarboxylic anhydride, 1,8-naphthalic anhydride, 1-naphthoic acid, naphthol blue black or naphthol Green B may be used as the ligand material.

4-Hydroxy-7-trifluoromethyl-3-quinolinecarboxylic acid, 3-hydroxy-2-quinolinecarboxylic acid, 2-hydroxy-5-(1H-pyrrol-1-yl)benzoic acid, 3-hydroxypicolinic acid, 2-(4-hydroxyphenylazo)benzoic acid, 2-hydroxynicotinic acid, 3-hydroxy-2-naphthoic acid, 2-hydroxy-1-naphthoic acid, 1-hydroxy-2-naphthoic acid, 3-hydroxy-2-methyl-4-quinolinecarboxylic acid, 2-hydroxy-6-methylpyridine-3-carboxylic acid or 2-hydroxy-3-isopropylbenzoic acid may be employed as the salicylic derivative.

The cathodic electrochromic material may exist as a powder of fine particles. Alternatively, the cathodic electrochromic material may be provided in the form of a colloid, solution or paste in a solvent or medium. The cathodic electrochromic material changes in color in response to light. Specifically, the cathodic electrochromic material may be electrically colored when a cathodic reaction occurs and bleached when an anodic reaction occurs. Tungsten oxide (WO₃), copper oxide (CuO), molybdenum oxide (MoO₃), vanadium oxide (V₂O₅), thallium oxide (Tl₂O) or niobium oxide (Nb₂O₅) may be used as the cathodic electrochromic material.

The cathodic electrochromic material is preferably in the form of a powder. However, the cathodic electrochromic material is likely to aggregate as its particle size decreases, which is disadvantageous in terms of handling. In view of this situation, the cathodic electrochromic material is provided in the form of a colloid or solution in an organic solvent or a paste containing an organic binder to achieve good handling or storability.

Preferably, the cathodic electrochromic material has an average particle diameter of 10 to 50 nm. If the particle diameter of the cathodic electrochromic material is less than 10 nm, electrochromism is difficult to achieve. Meanwhile, if the particle diameter of the cathodic electrochromic material exceeds 50 nm, the transmittance of the final product is lowered, deteriorating the characteristics of the product.

Like the cathodic electrochromic material, the semiconductor material may be provided in the form of a powder, colloid, solution or paste. The semiconductor material serves to provide paths for charge balance and migration when the cathodic electrochromic material undergoes electrochromism. For example, an n-type semiconductor material, titanium dioxide (TiO₂), zinc oxide (ZnO), niobium oxide (Nb₂O₅), tin oxide (SnO₂), zinc tin oxide (Zn₂SnO₄) or strontium titanium oxide (SrTiO₃) may be used as the semiconductor material.

Similarly to the cathodic electrochromic material, the semiconductor material particles is preferably provided in the form of a powder but may be in the form of a colloid or solution in an organic solvent or a paste containing an organic binder to achieve good handling or storability.

The semiconductor material may have a particle size of 10 to 50 nm. Meanwhile, if the particle size of the semiconductor material is less than 10 nm, the ligand may be not efficiently adsorbed to the semiconductor material. Meanwhile, if the particle size of the semiconductor material exceeds 50 nm, the transmittance of the final product is lowered, deteriorating the characteristics of the product.

The electron transport material is used for efficient transport of electrons to shorten the time needed for switching between bleaching and coloring. The electron transport material may include a transition metal or carbon-based electron transport medium.

Specifically, the transition metal is not limited as long as it is capable of rapid electron transport. The transition metal may be platinum or titanium.

The carbon-based electron transport medium is not limited as long as it is capable of rapid electron transport. The carbon-based electron transport medium may be a carbon nanotube aggregate, graphite, graphene or fullerene.

A self-powered electrochromic precursor prepared by this method includes a cathodic electrochromic mixture which is prepared by adding or adsorbing a ligand material to a cathodic electrochromic material, a semiconductor material or an electron transport material and whose color changes in response to light. The cathodic electrochromic mixture is in the form of particles, colloid, solution or paste, which is advantageous in terms of processability, handling, and storability. Due to these advantages, the cathodic electrochromic mixture can be used in various applications such as mirrors, displays, and optical switching devices as well as smart windows for buildings.

The kind of the cathodic electrochromic material, the particle diameter and average size of the cathodic electrochromic material, the kind of the semiconductor material, the particle size and average particle size of the semiconductor material, and the kind of the electron transport material are the same as or similar to those described in the preparation method, and a description thereof is thus omitted.

A method for fabricating a photoresponsive self-powered electrochromic device according to the present invention includes (S1) adding or adsorbing a ligand material to a cathodic electrochromic material, a semiconductor material or an electron transport material to prepare a cathodic electrochromic mixture whose color changes in response to light and fixing the cathodic electrochromic mixture to prepare a cathodic electrochromic composite in which electrically conductive paths are formed and (S2) immersing the cathodic electrochromic composite in an electrolyte.

Specifically, the ligand material may be previously adsorbed to the cathodic electrochromic material, the semiconductor material or the electron transport material before mixing. Alternatively, the ligand material may be added to the cathodic electrochromic material, the semiconductor material or the electron transport material by mixing. The cathodic electrochromic mixture changes in color in response to light. The cathodic electrochromic mixture is fixed to prepare a cathodic electrochromic composite in which electrically conductive paths are formed. Thereafter, the cathodic electrochromic composite is immersed in an electrolyte.

First, in step S1, electrically conductive paths are formed between the powders of the cathodic electrochromic mixture by fixing. Specifically, an organic solvent or binder is removed from the cathodic electrochromic mixture in the form of a powder, solution, colloid or paste, and the cathodic electrochromic material particles, the semiconductor material particles or the electron transport material particles are brought into intimate contact with each other to create an environment for electrical conduction.

This intimate contact is intended to include not only physical contact but also close contact to the extent that an electric current flows, that is, electrons or charges migrate easily, through an electrolyte.

The intimate contact for electrical conduction can be accomplished by fixing. The fixing is meant to form a structure in which the particles are located at distances such that charges can migrate. The fixing can be performed by heat treatment or pressing. The heating or pressing can be performed at a low or ultra-low pressure to facilitate removal of the organic solvent or binder.

The method may further include applying the cathodic electrochromic mixture to a substrate. The cathodic electrochromic mixture may be applied and fixed to a substrate such as a glass or polymer substrate that can be used in building windows and doors and automobile windows. The substrate is not especially limited as long as it is transparent.

For example, the pressing and heat treatment may be performed alone or in combination to form electrically conductive paths in the cathodic electrochromic mixture on the substrate. The cathodic electrochromic mixture in the form of a paste may be heat treated at a temperature of 300° C. or higher. The cathodic electrochromic mixture in the form of a colloid or solution may be heat treated at a temperature of 100° C. or higher.

The cathodic electrochromic mixture may be pressed at a pressure of 200 kg/cm² or higher. When the cathodic electrochromic mixture is applied to a glass substrate, heat treatment and pressing can be performed freely. When the cathodic electrochromic mixture is applied to a polymer substrate, pressing is mainly used but may be performed in combination with heat treatment at a temperature where the material characteristics of the polymer substrate are not impaired, that is, deformation (particularly, stretching) of the polymer substrate is not observed.

For example, the cathodic electrochromic mixture in the form of a colloid or solution may be applied to a polymer substrate, heat treated at a temperature of 100° C. or higher, and pressed at a pressure of 200 kg/cm² or higher to form electrically conductive paths.

In subsequent step S2, the cathodic electrochromic composite is immersed in an electrolyte to allow the electrolyte to penetrate into pores of the cathodic electrochromic composite.

The cathodic electrochromic composite has a mesoporous structure in which a number of pores exist three-dimensionally and are connected to each other between the fixed cathodic electrochromic material, semiconductor material or electron transport material or particles thereof and are connected to one another. The cathodic electrochromic composite is divided into the space taken up by the particles and the space taken up by the pores. The ratio of the space taken up by the particles and the space taken up by the pores is preferably from 3:7 to 7:3. If the space taken up by the particles is less than the lower limit (3:7) defined above, a sufficient color change is not obtained due to the small amount of the color change material. Meanwhile, if the space taken up by the particles exceeds the upper limit (7:3) defined above, a sufficient amount of the electrolyte is not introduced due to the small space taken up by the pores, making it difficult to achieve coloring and bleaching.

FIGS. 1 and 2 shows large and small spaces taken up by the particles, respectively.

The cathodic electrochromic composite is preferably from 50 nm to 20 μm in thickness. If the thickness of the cathodic electrochromic composite is less than 50 nm, a color change induced by cathodic electrochromism is not detected. Meanwhile, if the thickness of the cathodic electrochromic composite exceeds 20 μm, the transparency of the final product is reduced, causing poor appearance quality after bleaching, and the structural stability of the final product deteriorates, causing problems such as defects.

After the electrolyte is penetrated into the pores of the cathodic electrochromic composite, its ions participate in the electrochromic reactions of the cathodic electrochromic composite.

That is, when the ligand material is adsorbed to the semiconductor material, the cathodic electrochromic material, the electron transport material or particles thereof and light is irradiated thereon, the semiconductor material attached with the ligand absorbs the UV light or short-wavelength visible component of the light to excite electrons (e⁻) to the conduction band of the semiconductor material. At this time, holes are created in the HOMO of the ligand and the excited electrons are transferred to the adjacent cathodic electrochromic material to reduce the cathodic electrochromic material, achieving a color change, and anions in the electrolyte supply the electrons to the holes created in the HOMO of the ligand. This mechanism accounts for the electrochromic reactions of the cathodic electrochromic composite.

The electrolyte is not particularly limited as long as it participates in the above mechanism. The electrolyte includes lithium ions and may be, for example, a solution of LiI in 3-methoxypropionitrile or N,N-dimethylacetamide, a solution of LiBr in propylene carbonate or a solution of LiTFSi and LiBr in propylene carbonate. Alternatively, the electrolyte may be LiSCN, LiSeCN, HI, HBr, HSCN or HSeCN.

The cathodic electrochromic composite fixed to the substrate can be sealed in various ways. For this sealing, any means may be used without particular limitation. For example, the applied cathodic electrochromic composite may be covered with a polymer resin or glass material. The cathodic electrochromic composite may be sealed by stacking a finishing material (for example, Surlyn®) along the edge of the substrate, stacking a polymer resin material or glass material having an electrolyte injection inlet thereon, injecting the electrolyte through the injection inlet, and closing the inlet.

### Preparative Example 1

A titanium dioxide (TiO₂) powder was uniformly dispersed in a mixture of ethyl cellulose and terpinol to prepare a semiconductor material in the form of a paste. The titanium dioxide particles were present with an average particle diameter of 10-20 nm in the colloid. A tungsten oxide (WO₃) powder was uniformly dispersed in a mixture of ethyl cellulose and terpinol to prepare a cathodic electrochromic material in the form of a paste. The tungsten oxide particles were present with an average particle diameter of 10-50 nm. The semiconductor material was mixed with the cathodic electrochromic material.

### Preparative Example 2

A titanium dioxide (TiO₂) powder was uniformly dispersed in ethanol to prepare a semiconductor material in the form of a colloid. The titanium dioxide particles were present with an average particle diameter of 10-50 nm in the colloid. A tungsten oxide (WO₃) powder was uniformly dispersed in ethanol to prepare a cathodic electrochromic material in the form of a colloid. The tungsten oxide particles were present with an average particle diameter of 10-50 nm in the colloid. 5-Methylsalicylic acid as a ligand material was dissolved to a concentration of 1 M in a mixture of the semiconductor material and the cathodic electrochromic material.

### Preparative Example 3

A semiconductor material was prepared in the form of a paste containing titanium dioxide (TiO₂) particles in a mixture of ethyl cellulose and terpinol as a medium. The titanium dioxide particles were present with an average particle diameter of 10-50 nm in the paste. A cathodic electrochromic material was prepared in the form of a paste containing tungsten oxide (WO₃) particles in a mixture of ethyl cellulose and terpinol as a medium. The tungsten oxide particles were present with an average particle diameter of 10-50 nm in the paste. H₂PtCl₆ was mixed with ethyl cellulose and terpinol to prepare an electron transport material in the form of a platinum paste.

### Preparative Example 4

A tungsten oxide (WO₃) powder was uniformly dispersed in a mixture of ethyl cellulose and terpinol to prepare a cathodic electrochromic material in the form of a paste. The tungsten oxide particles were an average particle diameter of 10-50 nm. H₂PtCl₆ was mixed with ethyl cellulose and terpinol to prepare an electron transport material in the form of a platinum-containing paste. The cathodic electrochromic material was mixed with the electron transport material.

### Preparative Example 5

A titanium dioxide (TiO₂) powder was uniformly dispersed in a mixture of ethyl cellulose and terpinol to prepare a semiconductor material in the form of a paste. The titanium dioxide particles were present with an average particle diameter of 10-50 nm in the paste. A platinum-containing paste as an electron transport material was prepared by mixing H₂PtCl₆ with ethyl cellulose and terpinol. The semiconductor material was mixed with the electron transport material.

### Preparative Example 6

A titanium dioxide (TiO₂) powder was uniformly dispersed in a mixture of ethyl cellulose and terpinol to prepare a semiconductor material in the form of a paste. The titanium dioxide particles were present with an average particle diameter of 10-50 nm in the paste. A paste containing titanium nanoparticles with an average particle diameter of 5 nm in ethyl cellulose and terpinol as media was prepared as an electron transport material. The semiconductor material was mixed with the electron transport material.

### Preparative Example 7

A titanium dioxide (TiO₂) powder was uniformly dispersed in a mixture of ethyl cellulose and terpinol to prepare a semiconductor material in the form of a paste. The titanium dioxide particles were present with an average particle diameter of 10-50 nm in the paste. A paste containing 2-3 layers of graphene nanoparticles with an average size of 5 nm in ethyl cellulose and terpinol as media was prepared as an electron transport material. The semiconductor material was mixed with the electron transport material.

### Example 1

The mixture prepared in Preparative Example 1 was screen printed to a thickness of 5 μm on a first glass substrate and heat treated at 550° C. to form a film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 2

The mixture prepared in Preparative Example 2 was spin coated at 2000 rpm on a polycarbonate substrate, heat treated at 120° C., and pressurized at 400 kg/cm² to form a film. 0.1 g of nanosilica was mixed with 1 g of a 0.3 M solution of LiI in methoxypropionitrile to prepare a nanogel-type electrolyte. The nanogel-type electrolyte was printed on the film. The electrolyte-printed film was sealed with a polymer encapsulant at reduced pressure to fabricate a photoresponsive self-powered electrochromic device.

### Example 3

The mixture prepared in Preparative Example 3 was screen printed on a first glass substrate and heat treated at 550° C. to form a 1 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 4

The mixture prepared in Preparative Example 4 was screen printed on a first glass substrate and heat treated at 550° C. to form a 1 μm thick film. A titanium dioxide (TiO₂) powder was uniformly dispersed in a mixture of ethyl cellulose and terpinol to prepare a paste. The titanium dioxide particles were present with an average particle diameter of 10-50 nm in the paste. The paste was screen printed on the film and heat treated at 550° C. to form a 5 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 5

A tungsten oxide (WO₃) powder was uniformly dispersed in a mixture of ethyl cellulose and terpinol to prepare a paste. The tungsten oxide particles were present with an average particle diameter of 10-50 nm in the paste. The paste was screen printed on a first glass substrate and heat treated at 550° C. to form a 1 μm thick film. The mixture prepared in Preparative Example 5 was screen printed on the film and heat treated at 550° C. to form a 5 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 6

A tungsten oxide (WO₃) powder was uniformly dispersed in a mixture of ethyl cellulose and terpinol to prepare a paste. The tungsten oxide particles were present with an average particle diameter of 10-50 nm in the paste. The paste was screen printed on a first glass substrate and heat treated at 550° C. to form a 1 μm thick film. The mixture prepared in Preparative Example 6 was screen printed on the film and heat treated at 550° C. to form a 5 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 7

A tungsten oxide (WO₃) powder was uniformly dispersed in a mixture of ethyl cellulose and terpinol to prepare a paste. The tungsten oxide particles were present with an average particle diameter of 10-50 nm. The paste was screen printed on a first glass substrate and heat treated at 550° C. to form a 1 μm thick film. The mixture prepared in Preparative Example 7 was screen printed on the film and heat treated at 550° C. to form a 5 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Example 8

The mixture prepared in Preparative Example 4 was screen printed on a first glass substrate and heat treated at 550° C. to form a 1 μm thick film. The mixture prepared in Preparative Example 5 was screen printed on the film and heat treated at 550° C. to form a 5 μm thick film. Next, the film was immersed in a solution of 5-methylsalicylic acid as a ligand material for 2 h to adsorb the ligand thereto. Then, the ligand-adsorbed film was covered with a second glass substrate having an injection inlet such that the two glass substrates interposed the ligand-adsorbed film therebetween. Thereafter, the ligand-adsorbed film was sealed by stacking Surlyn® along the edge of the first glass substrate. An electrolyte (0.3 M LiI in methoxypropionitrile) was injected through the inlet, and the inlet was then closed to fabricate a photoresponsive self-powered electrochromic device.

### Experimental Example 1: Observation of Bleaching and Coloring

Changes in the color of the self-powered electrochromic devices fabricated in Examples 1 and 2 were observed after exposure to sunlight for 5 min. Bleaching of the self-powered electrochromic devices was observed in a darkroom. The results are shown in FIGS. 3 and 4.

FIGS. 3 and 4 reveal that the color of the photoresponsive self-powered electrochromic devices without conductive glass substrates changed in response to light.

Particularly, the self-powered electrochromic devices were initially transparent or very pale yellow and turned blue or green in color. Therefore, the self-powered electrochromic devices are expected to be applicable to fields where electrochromic glass is required. In addition, the self-powered electrochromic devices do not need to use any conductive glass substrates or expensive materials, which reduces their fabrication costs.

### Experimental Example 2: Transmittance Measurement

UV-Vis transmittance spectra for the colored and bleached states of the self-powered electrochromic devices fabricated in Examples 1 and 2 were recorded. The results are shown in FIGS. 5 and 6.

FIGS. 5 and 6 reveal that the transmittances of the bleached photoresponsive self-powered electrochromic devices were different by a factor of ˜2 from those of the colored self-powered electrochromic devices. These results demonstrate that the photoresponsive self-powered electrochromic devices including the photoresponsive self-powered electrochromic precursors are able to self-control the amount of light passing through the glass or transparent polymer films, indicating their ability to self-control the transmittance or reflectance of sunlight or other types of light when applied to building windows, automobile windows, automobile mirrors, automobile coating films, etc.

### Experimental Example 3: Evaluation of Time-Dependency of Bleaching

The transmittances of the self-powered electrochromic devices fabricated in Examples 1 and 2 were measured to evaluate the degrees of bleaching of the electrochromic devices over time. The results are shown in FIGS. 7 and 8. Particularly, the transmittances measured at a wavelength of 700 nm are shown in FIGS. 9 and 10.

Referring to FIGS. 7-10, the inventive self-powered electrochromic devices were colored by sunlight, and thereafter, they were bleached after sunlight was shut off. The ability of the electrochromic devices to self-control their coloring and bleaching is of technical significance. It took ˜4 h until complete bleaching of the self-powered electrochromic devices after light shut off.

The transmittances of the self-powered electrochromic devices fabricated in Examples 3 and 4 were measured over time to evaluate the degrees of bleaching of the electrochromic devices. The results are shown in FIGS. 11 and 12. Particularly, the transmittances measured at wavelengths of 550 nm and 700 nm are shown in FIG. 13.

The transmittances of the self-powered electrochromic devices fabricated in Examples 5-8 were also measured at wavelengths of 550 nm and 700 nm. The results are shown in FIG. 13.

Referring to FIGS. 11-13, the inventive self-powered electrochromic devices were colored by sunlight, and thereafter, they were bleached after sunlight was shut off. It was also confirmed that the bleaching of the self-powered electrochromic devices was accelerated by the electron transport materials.

### Experimental Example 4: Repetition of Coloring and Bleaching

The transmittances of the electrochromic devices fabricated in Examples 1 and 2 were measured during repeated cycles of coloring and bleaching of the electrochromic devices for 240 h. The results are shown in FIGS. 14 and 15. Particularly, the transmittances of the electrochromic devices measured at a wavelength of 700 nm are tabulated in FIGS. 16 and 17.

Referring to FIGS. 16 and 17, the inventive self-powered electrochromic devices were colored when irradiated with light and bleached when light was blocked. In addition, the inventive self-powered electrochromic devices could be used repeatedly. These results demonstrate that the inventive self-powered electrochromic devices can be applied to buildings and automobiles when tightly sealed.

1. A method for preparing a photoresponsive self-powered electrochromic precursor, comprising adding or adsorbing a ligand material to a cathodic electrochromic material, a semiconductor material or an electron transport material to prepare a cathodic electrochromic mixture whose color changes in response to light.

2. A photoresponsive self-powered electrochromic precursor comprising a cathodic electrochromic mixture which is prepared by adding or adsorbing a ligand material to a cathodic electrochromic material, a semiconductor material or an electron transport material and whose color changes in response to light wherein the cathodic electrochromic mixture is in the form of particles, colloid, solution or paste.

3. The photoresponsive self-powered electrochromic precursor according to claim 2, wherein the ligand material is salicylic acid, a salicylic acid derivative, catechol, salicylaldehyde, saccharine, salicylamide, 1,4,5,8-naphthalenetetracarboxylic acid, 1,4,5,8-naphthalenetetracarboxylic anhydride, 1,8-naphthalic anhydride, 1-naphthoic acid, naphthol blue black or naphthol Green B.

4. The photoresponsive self-powered electrochromic precursor according to claim 2, wherein the cathodic electrochromic material is tungsten oxide (WO₃), copper oxide (CuO), molybdenum oxide (MoO₃), vanadium oxide (V₂O₅), thallium oxide (Tl₂O) or niobium oxide (Nb₂O₅).

5. The photoresponsive self-powered electrochromic precursor according to claim 2, wherein the semiconductor material is an n-type semiconductor material, titanium dioxide (TiO₂), zinc oxide (ZnO), niobium oxide (Nb₂O₅), tin oxide (SnO₂), zinc tin oxide (Zn₂SnO₄) or strontium titanium oxide (SrTiO₃).

6. The photoresponsive self-powered electrochromic precursor according to claim 2, wherein the electron transport material comprises a transition metal or carbon-based electron transport medium.

7. The photoresponsive self-powered electrochromic precursor according to claim 6, wherein the transition metal comprises platinum or titanium.

8. The photoresponsive self-powered electrochromic precursor according to claim 6, wherein the carbon-based electron transport medium is a carbon nanotube aggregate, graphite, graphene or fullerene.

9. A method for fabricating a photoresponsive self-powered electrochromic device, comprising (S1) adding or adsorbing a ligand material to a cathodic electrochromic material, a semiconductor material or an electron transport material to prepare a cathodic electrochromic mixture whose color changes in response to light and fixing the cathodic electrochromic mixture to prepare a cathodic electrochromic composite in which electrically conductive paths are formed and (S2) immersing the cathodic electrochromic composite in an electrolyte.

10. The method according to claim 9, wherein, in step S1, the fixing comprises applying the cathodic electrochromic mixture to a substrate.

11. The method according to claim 9, wherein, in step S1, the fixing is performed by heat treatment or pressing to form electrically conductive paths.

12. The method according to claim 9, wherein the electrolyte comprises LiI, LiBr, LiSCN, LiSeCN, HI, HBr, HSCN or HSeCN.

13. A photoresponsive self-powered electrochromic device fabricated by adding or adsorbing a ligand material to a cathodic electrochromic material, a semiconductor material or an electron transport material to prepare a cathodic electrochromic mixture whose color changes in response to light, fixing the cathodic electrochromic mixture to prepare a cathodic electrochromic composite in which electrically conductive paths are formed, and immersing the cathodic electrochromic composite in an electrolyte.

14. The method according to claim 13, wherein the fixing is performed by applying the cathodic electrochromic mixture to a substrate.

15. The method according to claim 13, wherein the fixing is performed by heat treatment or pressing to form electrically conductive paths.

16. The method according to claim 13, wherein the ligand material is salicylic acid, a salicylic acid derivative, catechol, salicylaldehyde, saccharine, salicylamide, 1,4,5,8-naphthalenetetracarboxylic acid, 1,4,5,8-naphthalenetetracarboxylic anhydride, 1,8-naphthalic anhydride, 1-naphthoic acid, naphthol blue black or naphthol Green B.

17. The method according to claim 13, wherein the cathodic electrochromic material is tungsten oxide (WO₃), copper oxide (CuO), molybdenum oxide (MoO₃), vanadium oxide (V₂O₅), thallium oxide (Tl₂O) or niobium oxide (Nb₂O₅).

18. The method according to claim 13, wherein the semiconductor material is an n-type semiconductor material, titanium dioxide (TiO₂), zinc oxide (ZnO), niobium oxide (Nb₂O₅), tin oxide (SnO₂), zinc tin oxide (Zn₂SnO₄) or strontium titanium oxide (SrTiO₃).

19. The method according to claim 13, wherein the electron transport material comprises a transition metal or carbon-based electron transport medium.

20. The method according to claim 19, wherein the transition metal comprises platinum or titanium.

21. The method according to claim 19, wherein the carbon-based electron transport medium is a carbon nanotube aggregate, graphite, graphene or fullerene.

22. The method according to claim 13, wherein the cathodic electrochromic composite has a plurality of pores formed three-dimensionally.

23. The method according to claim 22, wherein the ratio of the space taken up by the plurality of pores to the volume of the cathodic electrochromic composite is from 3:7 to 7:3.
